(19) United States
(12) Patent Application Publication
(10) Pub. No.: US 2005/0080705 A1
(43) Pub. Date: Apr. 14, 2005

(54) Selling shares in intangible property over the internet

(76) Inventor: Naren Chaganti, Los Angeles, CA (US)

Correspondence Address: LAW OFFICES OF NAREN CHAGANTI, 432 S. CURSON AVE, STE. 12H, LOS ANGELES, CA, 90036, US

(21) Appl. No.: 10/988,105

(22) Filed: Nov. 12, 2004

Related U.S. Application Data
(63) Continuation of application No. 09/307,752, filed on May 10, 1999.

(51) Int. Cl. G06F 17/60

(52) U.S. Cl. 705/36

(57) ABSTRACT

A method and system for the use of an electronic apparatus to issue, list, price and trade property interests in intangible forms of property such as patents, trademarks, copyrights, goodwill, licenses, leases, easements, rights, a seafaring route and others; personal rights such as a right to future income of a person; special objects such as collectibles; and services such as a musician's concert recital time or a babysitter's time.

### FIELD OF THE INVENTION

This invention is related to the area of publicly traded securities and other financial instruments. In particular this invention is related to the use of an electronic apparatus to issue, list, price and trade property interests in intangible forms of property such as patents, trademarks, copyrights, goodwill, licenses, leases, easements, rights, a seafaring route and others; personal rights such as a right to future income of a person; special objects such as collectibles; and services such as a musician's concert recital time or a babysitter's time.

### BACKGROUND OF THE INVENTION

Markets exist today for many forms of property. The New York Stock Exchange and the National Association of Securities Dealers Quotation System (NASDAQ) provide market place for trading securities such as common and preferred stocks, and warrants on sale or purchase of stocks. The Chicago Board of Exchange (CBOE) and other market places provide a forum for sale and exchange of options and future interests in several securities and commodities such as wheat, soybeans, frozen concentrated orange juice, and pork bellies. Recently, the CBOE has started trading in electricity delivery contracts.

However, no publicly tradeable stock marketplace exists for the sale of certain non-corporate, non-commodity forms of property, for example, intangible property such as a patent, a trademark, a copyright in a painting, goodwill, licenses, leases, easements, rights, a seafaring route such as the right to navigate the Suez Canal, and other similar rights; personal rights such as a right to future income of a person; special objects such as collectibles; and services such as a musician's concert recital time or a babysitter's time, which are described and discussed in relation to the invention herein.

In many instances, where two businesses form a combination, each may possess rights to more or less equally popular trademarks. While after combination, the resulting business entity may wish to keep one trademark, it typically writes off or sells the other trademark to another business as a whole. If there exists a market place for securities derived from a single trademark or a combination of several trademarks held under a trust, then individuals who would like to own a portion of that property can secure interest that property alone without the encumbrance of owning a share of the common stock in a business that they are not interested.

Online stock trading has become possible with the proliferation of the interconnected public data communications networks, commonly called the Internet, and colloquially called the web. E-Trade, National Discount Brokers Online, Charles Schwab company, and many other organizations offer electronic trading services to individuals via the web. Typically in these services, a user connects to the web using a personal computer. Using a browser program such as the commonly used Netscape Navigator browser program, a user can lookup the prices of various stocks listed in a standard exchange such as the New York Stock Exchange.

There is a need, therefore, for a system and method to accommodate sales of such tangibles and intangibles in the marketplace and allow buyers and sellers to sell shares or rights to the earnings of intangibles to the highest bidder.

### SUMMARY OF THE INVENTION

In one aspect of a preferred embodiment, the invention is directed toward a method and system to issue, list, price and trade securities in certain forms of special property for which no publicly tradeable marketplaces currently exists.

In a preferred embodiment, the method includes inviting sellers and buyers to register and trade shares of special property comprising intangible property such as patents, trademarks, copyrights, leases, easements, right of way, air, land or sea route; objects such as a single collectible baseball, a communications satellite; personal rights such as a right to future income of a person, right to a person's life story; and services such as a musician's concert recital time or a babysitter's time. In another aspect, the invention comprises contacting a special property marketplace (SPMP) via a data communications network such as the Internet. In a yet another aspect, the invention comprises optionally appointing a manager and determining the rules of governance of the property rights involved. In a further aspect, the invention includes determining a marketable right; issuing a prospectus for shares in the right. Another aspect of the invention includes determining a price for a share of the right and storing it in a database. A further aspect of the invention includes posting the price on a data communications network. A yet another aspect of the invention includes registering a buyer, and/or a seller; receiving a bid price from the seller and/or an ask price from the buyer; matching a buyer with a seller and effecting a transaction.

### BRIEF DESCRIPTION OF THE DRAWINGS

These and other objects, features and advantages of the present invention will be more readily understood in the following detailed description of the preferred embodiments with a reference to the drawings, in which:

FIG. 1 is an architecture of a server computer connected to the Internet, to which a client computer is connected; and

FIG. 2 is a flow chart depicting the steps included in a preferred embodiment.

### DETAILED DESCRIPTION OF THE PREFERRED EMBODIMENTS

The present invention is directed toward creating a system and method of providing a marketplace for a portion of certain rights that constitute the “bundle” of rights inherent in a property interest. By creating such a market place, among other things, the dual purposes of providing liquidity and a way to gauge the popularity of the underlying property interest are achieved.

For example, rights in intangibles, such as a single piece or a collection of United States Letters Patent, or a copyright in a single film such as “Star Wars” can be bought and sold in a manner similar to certificates of ownership in joint stock companies are bought and sold. Persons who are interested in owning a portion of a famous film such as “Jurassic Park” or “The Titanic” are allowed to purchase shares of the films rather than the stock of companies that own good films along with bad films. Similarly, the rights to a popular trademark such as “Kodak” or other items such as an e-mail address, a web site name or a popular toll-free number such as “1-800-FLOWERS” are listed in marketplace.

Additionally, the present invention provides is a method and system for the sale of personal or business goodwill in the publicly traded securities market place. Popular scientists such as Albert Einstein, athletes such as the basketball superstar Michael Jordan or slugger Sammy Sosa, actors such as Clint Eastwood, and other celebrities such as comedian Jay Leno, a popular speaker such as a retired president of the United States, or even a controversial celebrity such as 0. J. Simpson may want to sell shares of their personal goodwill, or image and likeness in the open market for the highest bidder, preferably as a denominated security so that many persons can own a “piece of the celebrity.”

Furthermore, the invention is directed to creating and maintaining a marketplace for a right of ownership in a business method such as a “Method of selling software on the Internet” or other forms of property such as a “Method of dunking a basket ball,” a “Method of swinging a baseball bat,” a method of expression in music, writing, dance, or other forms of expression, any of which could be licensed to others. The invention creates a marketplace for such forms of property interests to allow interested buyers and sellers to own a portion or a share of such property, and have the value of the property appreciated over time without the need to having known the celebrity personally or being a writer or an artist themselves.

It is well known that the law recognizes a number of rights collectively called property rights. Until now, these “bundles of rights” are viewed in their entireties. In the realm of real property, there are the right to exclude a trespasser from a land, the right to rent or lease a plot of land, and the right to sell a piece of real estate. There are similar rights in all forms of property. For example, in a United States Letters Patent, an owner of the patent is entitled to exclude others from making, using or selling the invention that is patented for a period of years defined by the relevant statute. The present invention is a system and method wherein these rights are divided and sold separately to different bidders for different prices. In a preferred embodiment, the sale is performed as shares of stock in the totality of a particular right. The old-fashioned method is to license intellectual property on a one-on-one basis. The present invention makes these rights tradeable in the public marketplace. Additionally, the invention provides a method and system to trade values that are derived from these rights and makes them tradeable on a stock exchange such as the New York Stock Exchange. Thus, the invention is a method and system that enables a person to buy and sell either a single right or a collection of rights, make derived values and purchase or sell only certain derived values that are of interest to a person or entity without the need to own or sell the rights to the entire underlying property interest.

Certain unique treasures such as the Mona Lisa, visiting rights to the Taj Mahal, tourism rights to view the Sistine Chapel, a collection of antiques, rare books can be placed in the market place in the same way. Rare collectibles such as the manuscripts of Leonardo Da Vinci, the original notes for Dr. Martin Luther King's “I have a Dream” speech, notes made in book margins by the great scientist Albert Einstein, rare coins, and other items of historical importance such as the bus ticket used by Ms. Rosa Parks when she ignited the Civil Rights struggle, can also be traded if a public marketplace exists for these kinds of property. In the current invention, all items of value can be traded as rights. Some mundane rights can also be traded in the same way. These include right to have groceries delivered to a home; right to guaranteed baby-sitting; right to long-term care; right of companionship; recommendation to a job; right to receive training from a computer scientist; parking rights at a particular metro station; right to a guaranteed seat on an airplane; membership in a country club; a block of one million airline frequent-flier miles, etc.

Lately there is talk about obtaining genetic information from individuals and storing them in genetic databases to aid researchers in discovering signs of diseases early on in life so that they could be cured before they become malignant. Since human genes hold the secrets to the characteristics, inheritable or congenital diseases and other attributes of a human body, there is an interest in obtaining information about a person's genetic history to infer the likelihood of diseases that may afflict a person later in life. This information, since it holds the key to identifying or curing many diseases, could be a form of intangible property that can be traded on a listed exchange, if such an exchange exists.

These principles of the invention can be illustrated in the following way. Suppose that a babysitter X wants to have $10 to go to the movies. X sells 2 hours of babysitting on a particular Saturday to a Babysitting Stock Exchange for $10. Suppose Y is a busy lawyer who needs 2 hours of babysitting on that Saturday. The hours of baby sitting could be prescribed by either X, Y or by the Exchange. If the Exchange can sell the 2 hours of X's services to Y for more than $10, it will make a profit. If the Exchange could find no buyer by Saturday, the Exchange realizes nothing. In discussing this illustration, the quality of the babysitter's skills etc. are assumed to be “standard” or set by some method which is either subjective, objective method or even based on a bargaining process in a free market.

Other examples'of rights that can be publicly traded as shares are right to collect child-support payments, right to compensation for a personal injury, right to collect life insurance, social security, pension or other similar rights. In the United States, there are Federal and state laws that restrict the sale of certain kinds of rights. In other nations, these restrictions are either not present or being removed. As these restrictions are removed in the future, there will develop a marketplace for trading such rights.

The present invention is also directed toward creating a system and method for pricing property interests of the kinds illustrated above, advertising for such property interests, and effecting a sale of at least one of a plurality of shares of the property interest. A person skilled in the art of pricing securities or futures will use any alternative method or factor arrive at the price of a share of the securities. It should be noted that though only a certain types of properties are discussed in the foregoing, that discussion is by no means limited to the actual types of properties used as an illustration. Thus, the invented method and system should not be limited by the discussion provided herein.

The invention can be further illustrated in the following way. Values of different types of properties increase or decrease over time based on several factors. Suppose it were a future basketball superstar such as Michael Jordan in 1980. At that time, he was a college student, and reputably an upcoming basketball star. Or, the golf player Tiger Woods when he was under 10-years old. Knowing this information is of no use to someone who would like to contribute to the growth of Jordan's image and profit from such growth. Suppose, however, that Jordan declared 100 shares of the right to use his name, likeness or image in an advertisement in order to capitalize his career. For the purpose of discussion, let us consider that this stock has a symbol “DUNK.” These one hundred shares would have a “market” value in 1980 of probably $100,000, set by the standard price-setting process such as by a market maker or by a bargaining process. By 1998, however, it is reported that Jordan alone was responsible for generating sales in the amount of $10 Billion. -Assume that Michael Jordan's name, image or likeness contributed to one-tenth of this total revenue. This implies that the original 100 shares are worth in excess of $1 Billion, a capital appreciation of 10000 times the value of a share in 1980. Additionally, the shareholders of the DUNK stock will be entitled to the proceeds of licensing the name, image or likeness of Jordan in the form of dividends, after expenses and taxes. Even if one invested $1000 to buy a single share of DUNK in 1980, the market value of that single share in 1998 would be $10 million. By holding majority shares of DUNK, Jordan would be able to vote himself to control and direct the manner in which his name, image or likeness is commercially exploited. On the other hand, this interest can be purchased by another entity with perpetual rights to the licensing of Jordan's name or likeness.

Additionally, suppose Michael Jordan insures his feet for a high policy amount since they allow him to levitate against gravity. Assume that Lloyd's of London or other insurance company underwrites the insurance policy. In order to guard against the possibility that they may have to pay Jordan the value of the insurance policy, Lloyd's of London reinsures its policy by having other underwriters share the risk. If the insurance policy can be traded as a security and is listed in a standard exchange or a bulletin board for trading, say, under a ticker symbol “AIR,” the market place can widely distribute the bounty of the premiums paid by Jordan as well as the risk involved in the athlete's feet. Thus, the invention allows immediate liquidity to the name recognition of a celebrity as well as provides a means to have a number of persons “buy into” the celebrity's fame and fortune. In another embodiment, the invention trades the risk as an inverse or converse of the reward in the price of a share of “AIR.” Other derived values are created by calculating the mathematical or other probability of the risk involved in “AIR.” An advantage of the invention is that this method minimizes the risk by one entity by distributing it among a number of market participants.

The market price of shares can go down as well. For example, if a disaster with negative publicity implications occurs, the market price of a share of a trade mark may go down. If an athlete is determined to be unfit for professional sports, the shares representing his name or likeness may be worthless. In order to overcome the possibilities of negative fluctuations in value, there could be other derived values from the intangibles. Additionally, there is invented and described a mutual fund comprising shares of such special items to distribute the risk for an investor purchasing these shares among diverse entities.

It should be noted that there could be a temporal aspect to most of these rights. Some rights expire, whereas some don't. Some rights can be sold separately with a time limitation on them. For example, a share of DUNK can be further divided into a share of right to Michael Jordan's basketball earnings in the years 1992; share of right to his basketball earnings in the year 1996 etc. If Jordan retires in 1995 from playing basketball in a particular year and plays baseball, the holder of the right to his basketball earnings in 1995 will realize nothing by way of income. Such a holder would have been better off selling the share in 1993, when Jordan was the unbeaten champion of professional basketball, and realizing capital appreciation rather than waiting for income realized from Jordan's basketball earnings. If Jordan returns to playing basketball in 1996, and wins the championship again, then the price of 1996 shares would appreciate.

Some other rights may not exist at all at one time, but may come into being over time. Michael Jordan is not known for his baseball proficiency. But if he became equally good with baseball as he is will basketball, there could be issued shares in his image and likeness holding a baseball bat, his baseball swings, and the like. Certain shares may be more valuable during the retirement years, or even posthumous years of certain individuals. In the latter case, an executor or other parties who own the legal title to the individual can offer shares for sale in the marketplace. Another example of a right is a right to collect for patent infringement. The exclusive right granted for a United States Letters Patent is for a period of twenty years from the date of filing an application with the Patent Office. But a patentee may be able to bring a law suit and recover for infringement for up to 26 years from the date of the patent. Right to sue for infringement in the last, i.e., the twenty-sixth year may be much more valuable if a technology patented becomes increasingly more valuable in the marketplace.

In the following, we discuss the rights to a collectible article such as the Mona Lisa. A person of ordinary skill in the art of market making will easily substitute other forms of property. To illustrate the expenses and complexities involved, some details of implementation are described. The Mona Lisa is assumed to generate revenues from licensing images of the famous paintings. Additionally, art galleries may charge their visitors to make the Mona Lisa available to art connoisseurs. Thus, viewing rights, and reproduction rights or other rights to the original Mona Lisa generate revenues on a periodic basis. Assume that a Manager with fiduciary duties and powers to possess or control the underlying intangible property asset is created under a charter or an instrument such as a set of by-laws enforceable under the laws of a state in the United States or those of a foreign country. The Manager is authorized under the governing laws to issue certain number of shares of stock in the Mona Lisa. The maintenance and upkeep of the painting as well as expenses related to the publicity for the Mona Lisa will be paid for from the revenues received. The charter or the instrument that authorized the Manager may also authorize the Manager to make all reasonable expenses to maintain and publicize the painting. Under the charter, a majority vote may be required to elect the management, extend or limit their terms, set their compensation, and other operational details. Several classes of shares can be declared. There could be equity and non-equity shareholders. Additionally there could be holders of debentures or bonds who merely lend money to the Manager with a security interest in a particular type of right of the underlying property interest. The charter may declare that equity shareholders own the rights to change the Manager or liquidate the Manager and sell off the assets to the highest bidder and collect the proceeds.

It should be understood that though the above-mentioned description appears similar to the activities of the governance of a corporation, there are significant differences between the two. Here, the asset is non-corporate. Additionally, according to the present invention, trading shares in an electronic communication medium involves subject matter other than a corporate stock, bond, option, or futures contracts to delivery of commodities—the present invention pertains to intangible property; personal property rights; unique or special objects; or services—the subject matter, the kind of which, is currently not tradeable in a market place. Additionally, the market place could be a public or a private market place. It could be public, similar to the New York Stock Exchange, or it could be a “members-only” club.

In one embodiment of the invention, the rights to the ownership of the Mona Lisa are individually securitized, i.e., registered or unregistered shares of common, preferred or other stock certificates representing a property interest—either a right to capital appreciation or a right to receive profits in the form of dividends, or others—in these properties can be obtained. In order to be publicly available and traded in the marketplace, these securities are preferably listed under a stock symbol. It should be noted that the symbol is not an essential component of the invention. In an alternative embodiment, the Mona Lisa and all rights pertaining to its ownership are placed in a trust and shares of ownership interest in the trust can be offered for public sale and purchase as a security such as a stock. This trust could be the same or a different entity from the Manager described above.

The invented method and system can be utilized to securitize certain financial instruments such as rights of ownership or right to receive dividends in entities such as law firm partnerships; generating financial instruments such as bonds, credit accounts, and other similar securities derived from a core security. It should be noted that the general principles are slightly modified in the manners known to the persons skilled in the art to securitize different types of rights or properties in accordance with their particular features.

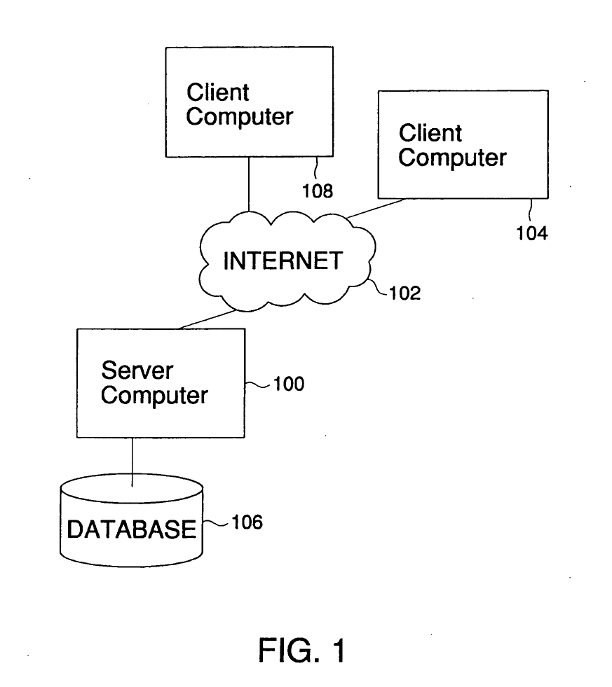

Referring now to the drawings, FIG. 1 depicts a server computer 100 connected to the Internet 102. Also connected to the Internet 102 is a client computer 104. In a preferred embodiment, all steps of the invention are practiced by way of electronic data communication messages or other electronic methods. In other embodiments, some steps are practiced by using devices such as E-mail, facsimile, telephone, courier or other methods.

In a preferred embodiment, the server computer 100 is a general purpose computer comprising a processor such as a Compaq Alpha microprocessor, a memory device such as semiconductor memory and a device to connect the computer to a communications network via a dial-up or a Local Area Network connection. Preferably the server computer 100 is configured to function as a web server. Coupled to the server computer 100 is a database 106 such as Oracle Relational Database Management System.

The client computer 104 is a personal computer comprising a processor such as a Pentium II microprocessor; an input device such as a keyboard or a mouse; a display device such as a CRT or a flat panel display; and an operating system such as Windows-95 Operating system. The client computer 100 is also equipped with a device to enable a dial-up connection to an Internet Service Provider such as America Online or Erols, Inc. In addition, the client computer 100 is equipped with a browser program such as Netscape Communicator that is configured to establish a connection to a web server and fetch web pages from the web server and display the fetched web pages on the display device. User inputs are captured by the software running on the client computer 104 and are interpreted according to the instructions resident either in the Operating system or another program such as the browser program.

In a preferred embodiment, the server computer 100 executes an operating system such as Linux or Windows-NT server. Software programs known as Common Gateway Interface (CGI) programs also execute on the server computer 100. These programs are preferably written in the programming language Perl. Alternatively, the CGI programs or other server-side programs are written in C, C++, Cold Fusion, or Java programming languages, or developed in the more recent MAWL programming language, published by Lucent Bell Labs. The server computer 100, when it is connected to the Internet 102, is configured to “listen” to the activity on the Internet 102 on a pre-determined address, typically represented in a dotted decimal notation or preferably in an alphanumeric form, such as http://www.specialpropertymarkteplace.com. The client computer 104 sends a request message, formatted in a Hyper Text Transfer Protocol (HTTP), and preferably encapsulated in a Transmission Control Protocol/Internet Protocol (TCP/IP) packet form, to the server computer 100. In a preferred embodiment, this is achieved by a user at the client computer 104 typing the address http://www.specialpropertymarkteplace.com, in a location on the browser program running on the client computer 104. The CGI program running on the server computer 100 receives the request message, and sends at least one response message to the client computer 104 in the HTTP protocol format. This response message contains a web page that is displayed in the browser of the client computer 104.

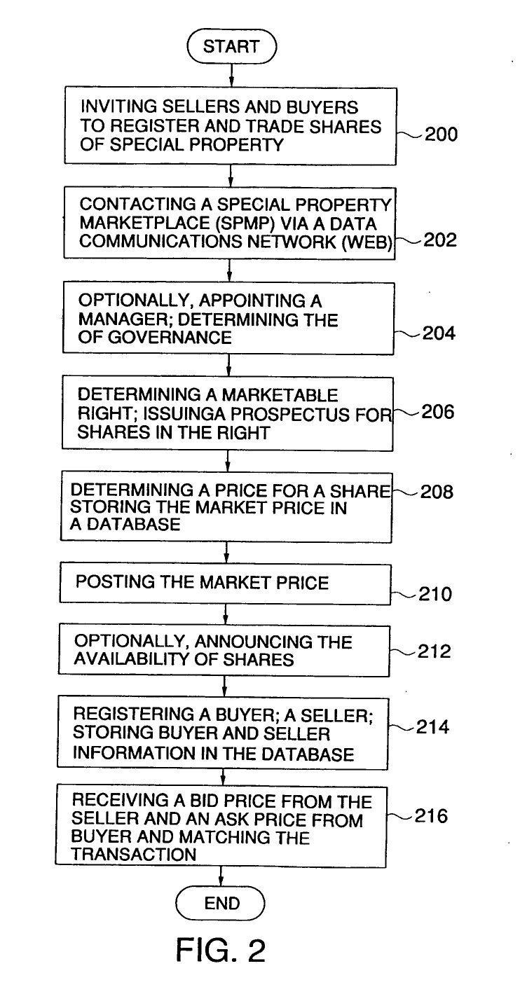

Referring now to FIG. 2, the present invention is preferably implemented in the form of a software program running on the server computer 100. An Special Property Market Place (SPMP) manages, directs or operates the server computer 100. The SPMP creates a web site such as http://www.specialpropertymarkteplace.com. The web site operated by the SPMP displays a web page that invites persons interested in trading in securities of special property. The web page is preferably written in Hyper-Text Markup Language (HTML). (Step 200).

In alternative embodiments, there are established secure communications links between the server computer 100 and the client computer 104 in any one of the secure communications methods known to persons of ordinary skill in the art. In other embodiments, Personal Identification Numbers (PIN) are issued to persons to identify their transactions. These PINs could be stored in the database 106 and a report could be generated of activities of individual users, a class of users, a type of property interest, etc. either periodically or upon demand by either the SPMP or by an individual user. In further alternative embodiments, the client computer 104 may send an identifier identifying a hardware component, such as a central processing unit or a communications processor included in the client computer 104 to enable the establishing the secure connection with the server computer 100.

A user X who wishes to market shares in a patent he owns approaches the SPMP. In another embodiment, the user X approaches a broker who can act as the user's agent and approach the SPMP by contacting the SPMP via either the Internet 102, or via other methods of communication such as E-mail, facsimile, telephone or courier. (Step 202).

In an alternative embodiment, a Manager is selected for the property interest to be marketed. The Manager enters into a contractual agreement with the owner of the property, or any person who has possessory interest in the property. A charter or a set of by-laws may define the ownership or other rights the Manager possesses in the property. The Manager is a fiduciary agent of the shareholders and is responsible for collecting income by licensing the patent, or promoting the property interest. The Manager may comprise a committee of individuals, each with a power to vote, and make decisions according to the provisions of the charter or the set of by-laws. It should be noted that this is an optional step and not required. (Step 204)

In the case of personal rights, the owner of the right generally is the person whose rights are traded. In case of an object such as a collectible, it could be decided based on an applicable law. It is assumed that trading shares in the marketplace may take place with or without the cooperation of the person who has such interest in the right. For example, a right to easement earned by an encroacher, who possessed the property adversely, may attempt to sell shares in the right as well. Additionally, there is no need for a broker, or even the SPMP acting as a middleman.

The broker or the SPMP determines a marketable right involving the patent. A U.S. Patent entitles a patentee to exclude others from making, selling, using or importing for sale to the United States for a period of 20 years from the date of filing. These rights are priced by the broker or the SPMP either in totality or in a divisible interest. For example, only the right to exclude others from importing during the tenth year of the filing of the patent is divided from the remaining rights and is constituted as 100 shares of this right. A symbolic name is given to this right, for example, PTNT-123-10YR. This name is stored in the database 106. A description of the property, any risks associated with the share as well as any opportunities for investment are displayed on the server computer 100 web page in a “Prospectus for the shares of PTNT-123-10YR.” (Step 206)

Further divisions of this right are possible. There could be issued simultaneously warrants or options on the right, or the Manager could announce share splits or reverse splits to make the rights more marketable.

The broker or the SPMP determines a market price for a share of PTNT-123-10YR. A computer program running on the server computer 100 comprises a method for enabling a user operating a client computer 104 using a web browser program to automatically price the share of PTNT-123-10YR. The market value can be determined by the amount of money that a willing purchaser pays to a willing seller, both of who are adequately informed of the choice. A person skilled in the art of appraising a new security will easily understand the numerous methods currently in practice to arrive at a price representing an approximate market price of the patent. A preferred embodiment uses a mere guessing of the price of the patent. Other examples of methods of pricing include Black-Sholes pricing formulae and other similar formulae. These formulae, when incorporated into a computer program, automatically calculate the price of a security—new or existing—based on a number of factors such as volatility of the share prices. The server computer 100 displays at least one of a plurality of web pages on the client computer 104, requesting input for several variable parameters used in the pricing formula. The user inputs these values into the server computer using the web browser. The pricing formula on the server computer thereafter computes a price for the share. The price is stored in the database 106. (Step 208)

After the server computer 100 computes the price of the share, it displays the price on its web page. (Step 210).

The server computer 100 announces, on a server computer 100 web page or other web pages, the availability of the shares for sale to the public. In other embodiments, there could be a private club, the members of which are notified via facsimile, E-mail, U.S. Mail, telephone, or courier, announcing the availability of the shares for purchase. (Step 212)

A buyer who wishes to purchase a few of shares of PTNT-123-10YR reads the Prospectus displayed on the server computer 100 and registers himself with the SPMP via the Internet 102. The server computer 100 displays a web page on a client computer operated by the buyer. The buyer enters his identification, mailing address for invoices or prospectuses, bank information in the web page. These pieces of information are stored in the database 106 for later retrieval. In alternative embodiments, the buyer may apply for a margin or credit with either the SPMP or with another lender and provide identification information of the availability of such credit to the SPMP via the server computer 100 web page. (Step 214)

The buyer enters the price at which he wishes to purchase the shares of PTNT-123-10YR in the server computer 100 web page. This price is stored in the database 106 and posted on the server computer 100 web page as an “ask” price. Similarly to the buyer, a seller of shares of PTNT-123-10YR also announces on the server computer 100 after registration, that he has a number of shares that he wishes to sell at a “bid” price. The bid price is stored in the database and optionally posted on the server computer 100 web page. Other registered buyers and sellers enter the prices at which they buy or sell the shares. These prices are stored in the database 106 and posted on the server computer 100 web page. The server computer 100 makes a match between a buyer and seller—the number of shares and the prices—and effects a sale, which is stored in the database. The server computer also notifies the buyer and seller by either displaying on the web page or by sending a notification via E-mail, facsimile, telephone or other means that they have accomplished a transaction. (Step 216).

A list of the persons who own shares of PTNT-123-10YR is transmitted to the Manager of the property upon demand or periodically. This is done by extracting the information from the database 106 and generating a report identifying the shareholders and their holdings, as well as any contact information.

When the Manager collects revenues for the property, he will send notifications or debit the accounts of shareholders of record any dividends or proceeds from the sale or issuance of any divided interest from the property such as further divisions of the property right. If new shares are issued, the Manager announces the availability on the server computer 100 web site and offers them for sale to the public. If stock splits are effected, they are registered with the server computer. The SPMP may, upon demand by any shareholder issue a share certificate and deliver it to the shareholder.

The foregoing describes a method and apparatus for issuing, pricing, listing and trading securities in certain special forms of property such as intangible property, personal rights, unique or special objects, and services over a communications network. Persons skilled in the art may make several modifications to the preferred embodiments described herein without undue experimentation or without departing from the spirit of the invention. For example, the order of the steps described in the method can be altered; some steps are described only to provide a general understanding of the invention and not as a limitation of the principles involved. Accordingly all such departures are within the scope of the claims which are as follows.

1. A method of providing an electronic marketplace for a share of an intellectual property asset, the method comprising the steps of:
determining the price of a share of the intellectual property;
listing the share in an electronic market place; and
selling the share.

2. The method of claim 1 wherein the intellectual property asset is a patent, a trademark, or a copyright.

3. An asset portfolio comprising:
a share of an intangible property asset.

4. An asset portfolio comprising:
a right to purchase or sell a share of an intellectual property asset.
